(19) United States
(12) Patent Application Publication
(10) Pub. No.: US 2011/0099380 A1
(43) Pub. Date: Apr. 28, 2011

(54) System and Method of Controlling Access to Information Content Transmitted Over Communication Network

(76) Inventor: Eric Johannes Vandewater, Scottsdale, AZ (US)

(21) Appl. No.: 12/605,289

(22) Filed: Oct. 23, 2009

(51) Int. Cl. H04L 9/32; G06F 21/00

(52) U.S. Cl. 713/176; 726/4

(57) ABSTRACT

An electronic communication system provides sender controlled access to electronic communications transmitted through an electronic communication network. A sender profile and recipient profile are registered with an electronic content service provider. An electronic communication with information content is transmitted from a sender computer to the electronic content service provider. A signature is generated unique to the electronic communication. The signature without the information content is transmitted to a recipient computer. The information content of the electronic communication is accessed by transmitting an authorization based on the recipient profile from the recipient computer to the electronic content service provider. The information content of the electronic communication is transmitted from the electronic content service provider through the electronic communication network to the recipient computer with restricted access as determined by the sender computer upon confirmation of the authorization. If the authorization is not confirmed, access to the electronic communication is blocked.

### FIELD OF THE INVENTION

The present invention relates in general to electronic communication systems and, more particularly, to a system and method of controlling access to information content transmitted over an electronic communication network.

### BACKGROUND OF THE INVENTION

People use electronic communications in virtually every phase of business and personal activities. The electronic communication is conducted through the Internet and its wired and wireless communication channels and pathways. For example, electronic communication may involve sending and receiving emails containing text and possibly one or more attachments, such as figures, photos, video, files, or documents. The electronic communication can also involve downloading or uploading documents, data files, and video content on remote servers and websites.

The lack of privacy and control of the electronic communications sent over the Internet presents a significant issue to businesses and individuals. Once the send button is pressed, the email and its attachments are transferred to and physically present on the recipient's email service provider server. The recipient can open the email, review and save its content, print the content, modify the content, add commentary, forward the email to others, and conduct any other activity associated with the email without knowledge or consent of the sender. The sender loses all control and tracking of the email and its content. If the sender was aware of certain copying or forwarding activity, he or she may object. However, the sender seldom knows about the unauthorized activity of the email and, in any event, the damage is likely already done. The email content can be detrimental, embarrassing, or otherwise counter to the interests of the sender. The common rule is that if you send an email, assume the rest of the world may get access to the content of the email. There is no presumption of privacy when sending email.

In another example, if a user uploads a document to a remote server or website, the document is transferred to and physically present on the remote server. For example, a sender may upload a confidential document to a business consortium or association website intended for customers. Once uploaded, the document physically resides on the business association server, out of the sender's direct control. The manager of the website, and possibly users of the website, can open the document, review and save its content, print the content, modify the content, add commentary, forward the document to others, and conduct any other activity associated with the document without knowledge or consent of the sender. The sender is now dependent on the consortium website to regulate access to the document as intended by the sender. However, the security is typically not difficult to breach. The customer may, for its own benefit, even give the document to a competitor of the sender.

In each case, the sender loses control over information content contained in electronic communications once transmitted over the Internet. Due to the public nature of the Internet, the information content is “out there”, potentially available to anyone, and can be used in a manner that is detrimental, embarrassing, or otherwise counter to the interests of the sender.

In most business activities, the subject matter of the email or uploaded documents changes over time. The sender may transmit one version of text or a file attached to the email to the recipient, and later transmit an updated version of the text or file attached to the email. The multiple versions of the text and files attached to multiple emails can cause confusion, miscommunication, and errors in the business activity.

### SUMMARY OF THE INVENTION

A need exists to control access to electronic communications. Accordingly, in one embodiment, the present invention is a method of controlling access to information content transmitted through an electronic communication network comprising the steps of registering a sender profile and recipient profile with an electronic content service provider, transmitting an electronic communication with information content from a sender computer through the electronic communication network to the electronic content service provider, generating a signature unique to the electronic communication, transmitting the signature without the information content to a recipient computer, accessing the information content of the electronic communication by transmitting an authorization based on the recipient profile from the recipient computer to the electronic content service provider, transmitting the information content of the electronic communication from the electronic content service provider through the electronic communication network to the recipient computer with restricted access as determined by the sender computer upon confirmation of the authorization, and blocking access to the information content of the electronic communication if the authorization is not confirmed.

In another embodiment, the present invention is a method of controlling access to information content transmitted through an electronic communication network comprising the steps of transmitting an electronic communication with information content from a sender computer through the electronic communication network to the electronic content service provider, generating a signature unique to the electronic communication, transmitting the signature without the information content to a recipient computer, accessing the information content of the electronic communication by transmitting an authorization from the recipient computer to the electronic content service provider, and transmitting the information content of the electronic communication from the electronic content service provider through the electronic communication network to the recipient computer with restricted access as determined by the sender computer.

In another embodiment, the present invention is a method of controlling access to information content transmitted through an electronic communication network comprising the steps of transmitting an electronic communication link without the information content from a sender computer to a recipient computer, transmitting an authorization from the recipient computer to the sender computer, and transmitting the information content of the electronic communication from the sender computer through the electronic communication network to the recipient computer with restricted access as determined by the sender computer upon confirmation of the authorization.

In another embodiment, the present invention is a computer program product comprising computer readable program code embodied in a computer usable medium. The computer readable program code is adapted to implement a method for controlling access to information content transmitted through an electronic communication network comprising the steps of transmitting an electronic communication with information content from a sender computer through the electronic communication network to an electronic content service provider, generating a signature unique to the electronic communication, transmitting the signature without the information content to a recipient computer, accessing the information content of the electronic communication by transmitting an authorization from the recipient computer to the electronic content service provider, and transmitting the information content of the electronic communication from the electronic content service provider through the electronic communication network to the recipient computer with restricted access as determined by the sender computer.

### BRIEF DESCRIPTION OF THE DRAWINGS

FIG. 1 is a block diagram of an electronic communication system used for business, commercial, personal, educational, government, and public interest purposes;

FIG. 2 illustrates further detail of a computer system for use with the electronic communication system;

FIG. 3 is a webpage for registering with an electronic content service provider;

FIG. 4 is a webpage for logging into the electronic content service provider;

FIG. 5 illustrates electronic communication links between the sender computer, recipient computer, and electronic content service provider;

FIG. 6 is a webpage for managing electronic messages on the electronic content service provider;

FIG. 7 illustrates a window for composing a secure message and generating a signature;

FIG. 8 illustrates the signature inserted into a new email window on the sender computer;

FIG. 9 illustrates the received email with enclosed signature on the recipient computer;

FIG. 10 illustrates the secure message displayed on the recipient computer;

FIG. 11 illustrates the sender posting a secure message to a third party webpage;

FIG. 12 illustrates the third party webpage with signature on the recipient computer;

FIG. 13 illustrates the secure message displayed on the recipient computer;

FIG. 14 illustrates a window for composing a secure email with attachments;

FIG. 15 illustrates an email communication notification window on the recipient computer;

FIG. 16 illustrates the content of the secure email displayed on the recipient computer;

FIG. 17 illustrates electronic communication between the sender computer, recipient computer, electronic content service provider, and business association computer;

FIG. 18 is a webpage for managing sender documents on the electronic content service provider;

FIG. 19 is a webpage for the sender to upload a document to the electronic content service provider;

FIG. 20 is a block diagram of a confirmation protocol providing sender control over email communication between the sender computer and recipient computer;

FIG. 21 is a block diagram of the confirmation protocol providing sender control over a document link uploaded to a business association computer;

FIG. 22 is a flowchart of a process of controlling access to information content transmitted through the electronic communication network; and

FIG. 23 is a flowchart of another process of controlling access to information content transmitted through the electronic communication network.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

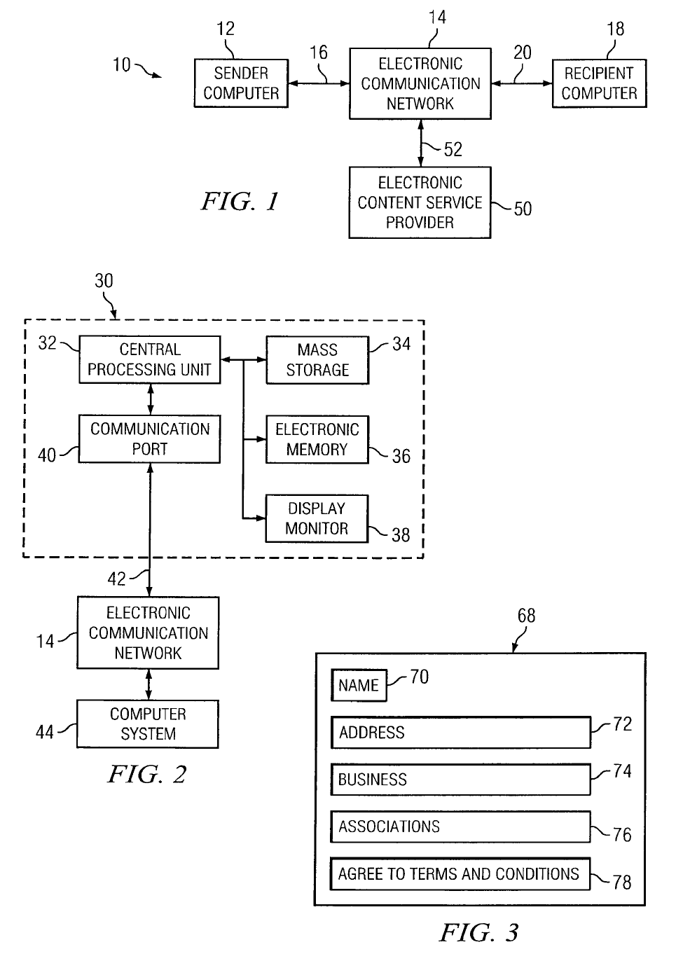

FIG. 1 shows an electronic communication system 10 for transmitting information between users. Sender computer 12 is connected to electronic communication network 14 by way of communication channel or link 16. Likewise, recipient computer 18 is connected to electronic communication network 14 by way of communication channel or link 20. The electronic communication network 14 is a distributed system of interconnected routers, gateways, switches, and servers, each with a unique address to enable communication between individual computer or nodes within the system. In one embodiment, electronic communication network 14 is a global, open-architecture network commonly known as the Internet. Communication channels 16 and 20 are bi-directional and transmit data between sender computer 12 and recipient computer 18 and electronic communication network 14 in a hard-wired or wireless configuration.

The electronic communication system 10 can be used for a variety of business, commercial, personal, educational, and government purposes or functions. For example, a retailer on computer 12 may communicate with a distributor or manufacturer on computer 18; a business service provider on computer 12 may communicate with a client on computer 18; a financial institution on computer 12 may communicate with a customer on computer 18; a government agency on computer 12 may communicate with an individual on computer 18; a student on computer 12 may communicate with a college professor on computer 18; an individual on computer 12 may communicate with a friend on computer 18. The electronic communication system 10 is an integral part of a business, commercial, professional, educational, government, or social network involving the interaction of people, processes, and commerce.

Further detail of the computer systems used in electronic communication system 10 is shown in FIG. 2 as a simplified computer system 30 for executing the software program used in the electronic communication process. Computer system 30 is a general purpose computer including a central processing unit or microprocessor 32, mass storage device or hard disk 34, electronic memory 36, display monitor 38, and communication port 40. Communication port 40 represents a modem, high-speed Ethernet link, wireless, or other electronic connection to transmit and receive input/output (I/O) data over communication link 42 to electronic communication network 14. Computer system or server 44 can be configured as shown for computer 30. Computer system 44 transmits and receives information and data over communication network 14.

Computer systems 30 and 44 can be physically located in any location with access to a modem or communication link to network 14. For example, computer 30 can be located in the sender or recipient business office. Alternatively, computer 30 can be mobile and follow the users to any convenient location, e.g., remote offices, customer locations, hotel rooms, residences, vehicles, public places, or other locales with electronic access to electronic communication network 14.

Each of the computers runs application software and computer programs, which can be used to display user interface screens, execute the functionality, and provide the electronic communication features as described below. The application software includes a local email application, Internet browser, word processor, spreadsheet, and the like. In one embodiment, the screens and functionality come from the application software, i.e., the electronic communication runs directly on computer system 30. Alternatively, the screens and functions are provided remotely from one or more websites on servers within electronic communication network 14.

The software is originally provided on computer readable media, such as compact disks (CDs), external drive, or other mass storage medium. Alternatively, the software is downloaded from electronic links, such as the host or vendor website. The software is installed onto the computer system hard drive 34 and/or electronic memory 36, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer program medium.

The electronic communication system 10 provides the ability for sender computer 12 to transmit and receive secure electronic communication with respect to recipient computer 18. The electronic communication system 10 further includes electronic content service provider 50 in electronic communication with network 14 over communication channel or link 52. Communication channel 52 is bi-directional and transmits data between electronic content service provider 50 and electronic communication network 14 in a hard-wired or wireless configuration. The electronic content service provider 50 may use computer system 44 in its business office. As discussed in detail below, the purpose of electronic content service provider 50 is to enable electronic communication between sender computer 12 and recipient computer 18, while maintaining sender control over the content of the communication.

Consider an example where a user of sender computer 12 (sender) needs to sends a secure electronic message to a user of recipient computer 18 (recipient). The sender considers the electronic message to be confidential. The sender first creates an account and profile with electronic content service provider 50. The account may involve a registration process wherein the sender accesses website 68 operated by electronic content service provider 50 and provides data to complete the registration and activation process, as shown in FIG. 3. The data provided by the sender to electronic content service provider 50 may include name in block 70, address in block 72, type of business in block 74, associations in block 76, and other information and credentials necessary to establish a profile and identity for each sender. The sender profile can also contain employer, occupation, financial data, interests, associations, religion, marital status, and the like. The sender may, of course, elect not to provide certain information, which may affect authorization status and ability to receive communications from others. The sender agrees to the terms and conditions of conducting electronic communication through service provider 50 in block 78. The sender's profile is stored on electronic content service provider 50.

The electronic content service provider 50 generates object code or plug-in, which is transmitted to and stored on sender computer 12. The plug-in enables authentication and communication with electronic content service provider 50. The plug-in further monitors incoming messages in the local email application and webpages retrieved with the Internet browser on sender computer 12.

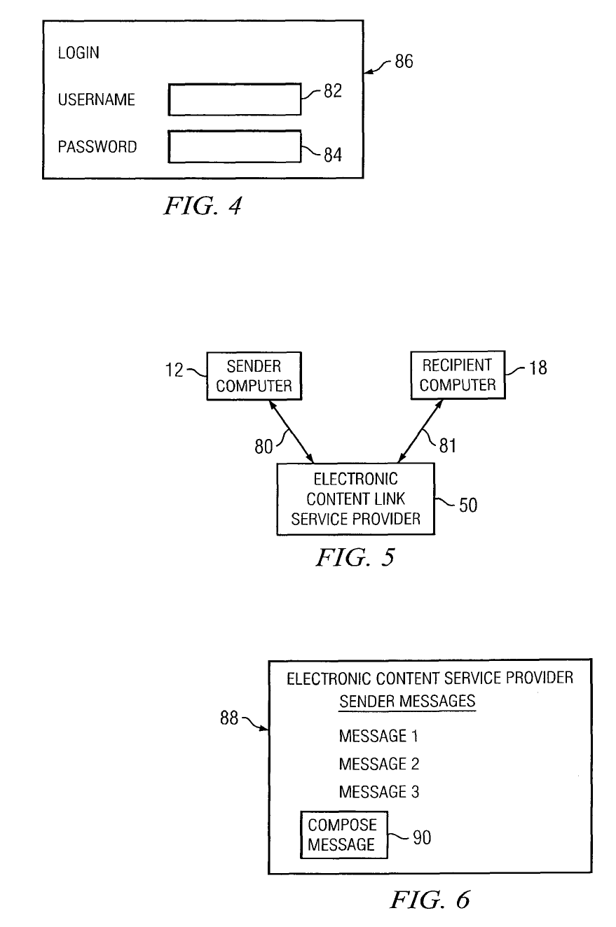

To send a secure electronic message, the sender first enters username 82 and password 84 in login screen 86 as provided by the local plug-in, as shown in FIG. 4. The plug-in can provide the option to store the login information for future use, allowing the login screen to be bypassed next time the plug-in is started. The sender remains authenticated until logged out or the plug-in is stopped. Once the sender is authenticated, the plug-in directs the sender to the website of electronic content service provider 50 by link 80, as shown in FIG. 5. Link 80 represents part of a communication protocol enabled through communication channel 16, electronic communication network 14, and communication channel 52. The sender is presented with webpage 88 on electronic content service provider 50 to manage secure electronic messages, as shown in FIG. 6. Webpage 88 shows electronic messages that have been created using electronic content service provider 50. The sender selects compose message button 90.

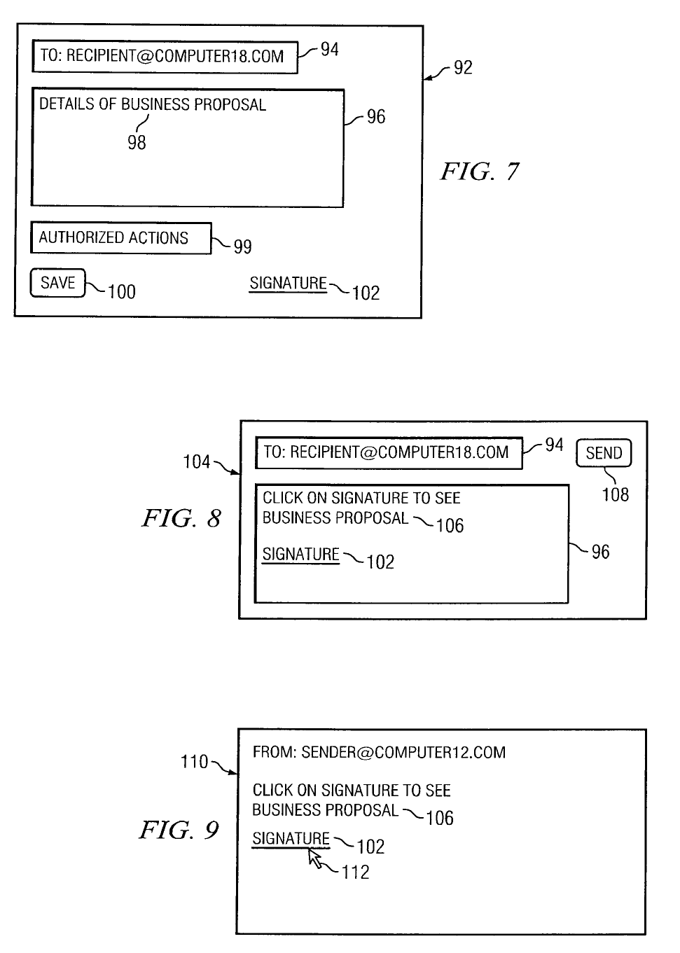

A message composition webpage or window 92 is presented on sender computer 12, such as shown in FIG. 7. The sender composes the secure message including recipient(s) authorized to receive the secure message in block 94. The message may also contain text, figures, pictures, video, and any other content typically used on the Internet. The sender can also identify specific parties or classes not authorized to receive the secure message. For example, the secure message may be a business proposal which is not intended to be viewed by anyone associated with the sender's competitors. The text of the secure message is entered in block 96. In this case, the content of secure message 98 contains the details of the business proposal. The actions authorized by the sender, e.g., viewing but no saving, copying, printing, or forwarding, are defined in authorized actions block 99. When the sender clicks save button 100, the secure message is stored on electronic content service provider 50 for later retrieval by the authorized recipient.

The electronic content service provider 50 also generates a signature 102 as a unique identifier of secure message 98. The signature is shown to the sender as plain text in window 92. Alternatively, the signature can be embedded in a standard picture, or in a custom picture provided by the sender. The sender copies signature 102. The sender then accesses a new email window using the local email application on sender computer 12. FIG. 8 shows a new email window 104 of the local email application on sender computer 12. The sender inserts signature 102 in the new email window 104 using a standard copy/paste operation or by manually typing the text-based signature. The sender can also add non-secure text 106 in the new email window 104 to explain signature 102 and associated secure message 98 (to be subsequently sent) to the recipient. The sender presses the local email application send button 108 to transmit the email with enclosed signature 102 to the recipient.

The recipient also creates an account and profile with electronic content service provider 50. The account may involve a registration process wherein the recipient accesses the website operated by electronic content service provider 50 and provides data to complete the registration and activation process, similar to FIG. 3. The data provided by the recipient to electronic content service provider 50 may include name, address, type of business, associations, and other information and credentials necessary to establish a profile and identity for each recipient. The recipient profile can also contain employer, occupation, financial data, interests, associations, religion, marital status, and the like. The recipient may, of course, elect not to provide certain information, which may affect the authorization status and ability to receive communications from others. The recipient agrees to the terms and conditions of conducting electronic communication through service provider 50. The recipient's profile is stored on electronic content service provider 50.

The electronic content service provider 50 generates object code or plug-in, which is transmitted to and stored on recipient computer 18. The plug-in enables authentication and communication with electronic content service provider 50. The plug-in further monitors incoming messages in the local email application and webpages retrieved with the Internet browser on recipient computer 18.

To view the received email, including secure message 98 associated with the enclosed signature 102, the recipient accesses the local email application on recipient computer 18 and opens the email from the sender. FIG. 9 shows email window 110 with non-secure text 106 and signature 102 on recipient computer 18. The recipient can see the non-secure text 106 and enclosed signature 102 but not the content of secure message 98 associated with the signature. Using pointing device 112, the recipient points to or clicks on signature 102 enclosed in the email. The plug-in installed on recipient computer 18 recognizes signature 102 as a link to electronic content service provider 50 where the secure message is stored.

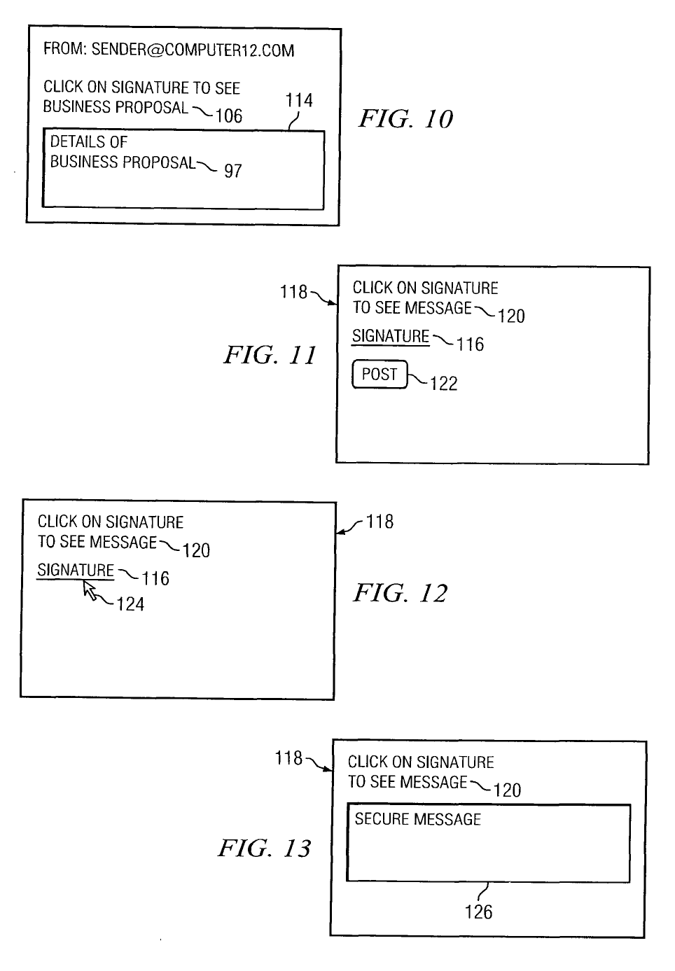

The recipient is prompted to enter username and password in the login screen, similar to FIG. 4. The plug-in can provide the option to store the login information for future use, allowing the login screen to be bypassed next time the plug-in is started. The recipient remains authenticated until logged out or the plug-in is stopped. The username and password authenticates the recipient, based on the recipient's profile, as being authorized to receive the content of the secure message in accordance with the sender's instructions. The username and password for the recipient are sent to electronic content service provider 50 to authorize receiving the content of the secure message. Once the recipient is authenticated, a request is sent to electronic content service provider 50 by link 81 in FIG. 5 to retrieve secure message 98. Link 81 represents part of a communication protocol enabled through communication channel 52, electronic communication network 14, and communication channel 20. The electronic content service provider 50 sends the content of secure message 98 to recipient computer 18. The content of secure message 98 is displayed in the email window or other pop-up message window 114 on recipient computer 18, as shown in FIG. 10. The recipient can then view the content of secure message 98 originating from the sender.

In another embodiment, when the sender presses the save button 100, the electronic content service provider 50 generates an email with enclosed signature 102 directly, without copy and paste operation to the local email application, and transmits the email to recipient computer 18 by link 81. The recipient receives and opens the email, similar to FIG. 9. The recipient can see the non-secure text 106 and enclosed signature 102 but not the content of secure message 98 associated with the signature. The recipient points to or clicks on the signature 102 enclosed in the email. The plug-in installed on recipient computer 18 recognizes signature 102 as a link to electronic content service provider 50 where the secure message is stored.

The recipient is prompted to enter username and password in the login screen, similar to FIG. 4. The username and password authenticates the recipient, based on the recipient's profile, as being authorized to receive the content of the secure message in accordance with the sender's instructions. The username and password for the recipient are sent to electronic content service provider 50 to authorize receiving the content of the secure message. Once the recipient is authenticated, a request is sent to electronic content service provider 50 by link 81 in FIG. 5 to retrieve secure message 98. The electronic content service provider 50 sends the content of secure message 98 to recipient computer 18. The content of secure message 98 is displayed in the email window or other pop-up message window on recipient computer 18, similar to FIG. 10. The recipient can then view the content of secure message 98 originating from the sender.

The message window 114 is controlled by the object code on recipient computer 18, rather than the local email application. The object code on sender computer 12, recipient computer 18, and electronic content service provider 50 form a confirmation protocol or electronic handshake to establish authorization to view, i.e., who can read the content of secure message 98. The sender defines the intended or authorized recipient, as well as specific parties and classes not authorized to view the secure message. The recipient confirms that he or she is the intended recipient by returning the recipient's authorization with the communication protocol link back to electronic content service provider 50. The electronic content service provider 50 recognizes the communication protocol link back from recipient computer 18, confirms the recipient as being authorized to view secure message 98, and sends the content for viewing in message window 114 on recipient computer 18 under a restricted access. The recipient can then view the content of secure message 98 in window 114. If the recipient's authorization cannot be verified by electronic content service provider 50, then access is denied and secure message 98 is not sent to recipient computer 18. An error message indicating that the recipient is not authorized to receive secure message 98 is sent instead.

The restricted access limits the use of secure message 98 on recipient computer 18. In response to receiving secure message 98 under restricted access, the object code on recipient computer 18 can inhibit forwarding, printing, local saving, or otherwise duplicating the content of the secure message. The recipient can do only what the sender authorizes, e.g., view secure message 98 on the computer display, but prevents unauthorized use of the content, e.g., printing, local saving, posting to another website, or otherwise transferring the content of the secure message to others. In any case, the restricted access is controllable by the sender.

The electronic handshake or confirmation protocol occurs each time the recipient opens or refreshes secure message 98 from the sender. Thus, at any time, even after secure message 98 has been “sent”, sender computer 12 can terminate access or otherwise change access privileges to secure message 98 on electronic content service provider 50. In the secure message of FIG. 7, if the new business proposal becomes null and void, the sender can prohibit further viewing or other dissemination of secure message 98. The sender sets secure message 98 stored on electronic content service provider 50 to terminate access to the secure message. The electronic content service provider 50 will block all subsequent attempts to access secure message 98. The next time the recipient attempts to access secure message 98, access will be denied. Accordingly, electronic content service provider 50 has enabled the sender and recipient to send and receive secure messages, but the sender has retained control over the content of the secure message. The recipient cannot forward, post, or copy secure message 98, without the sender's knowledge or consent. The recipient can view secure message 98 only to the extent authorized by the sender and so long as the sender enables the recipient to do so.

The sender can also update the content associated with secure message 98 at any time. In the secure message of FIG. 7, if the new business proposal changes, the text of secure message 98 can be updated by the sender on electronic content service provider 50 and subsequent viewing of secure message 98 reflects the latest information. Each time the recipient opens or refreshes secure message 98, the then current state of the content as stored on electronic content service provider computer 50, is sent to recipient computer 18 for viewing under restricted access as defined by the sender. The issue of multiple versions of secure message 98 is resolved as only the most up-to-date content is transmitted to the recipient. The sender maintains control over the content of secure message 98.

Privacy is always a concern when communicating over electronic network 14. The sender and recipient information obtained by electronic content service provider 50 can be maintained strictly confidential. The ability to provide sender controlled electronic communication for viewing of confidential content to authorized recipients, while maintaining privacy of the information given by the recipient in order to confirm authorization to view the content is an advantageous feature of electronic content service provider 50.

The electronic content service provider 50 exercises control over electronic communication system 10 under direction of the sender. The business, commercial, professional, educational, government, or personal system described in FIG. 1 is controlled by regulating access to the electronic communications. For example, in the business proposal contained in the secure message of FIG. 7, the sender can terminate the further action between the parties by disabling access to the secure message. In another example, an individual can disable access to a confidential message sent to a friend. The ability for the sender to retain control over electronic communications is a novel and useful aspect of electronic communication system 10.

In another embodiment, the sender needs to post a secure electronic message on a third party website on a remote server, e.g., a social interaction website. The sender considers the electronic message to be confidential. To post a secure electronic message, the sender first enters username 82 and password 84 in login screen 86 as provided by the local plug-in in FIG. 4. Once the sender is authenticated, the plug-in directs the sender to the website of electronic content service provider 50, similar to FIG. 6. The sender composes the secure message, as described in FIG. 7. The electronic content service provider 50 creates a signature as a unique identifier of the secure message, as described in FIG. 8.

The sender accesses the third party website where the secure message is to be posted, as shown in FIG. 11. The sender inserts signature 116 in webpage 118 using a standard copy/paste operation or by manually typing the text-based signature. The sender can also add non-secure text 120 in webpage 118 to explain signature 116 and associated secure message (to be subsequently sent) to the recipient. The sender presses the post button 122 to post signature 116 on webpage 118.

To view the posted message, the recipient opens webpage 118 with non-secure text 120 and signature 116 on recipient computer 18. The recipient can see the non-secure text 120 and enclosed signature 116 but not the content of the secure message associated with the signature, as shown in FIG. 12. Using pointing device 124, the recipient points to or clicks on signature 116 posted on webpage 118. The plug-in installed on recipient computer 18 recognizes signature 116 as a link to electronic content service provider 50 where the secure message is stored.

The recipient is prompted to enter username and password in the login screen, similar to FIG. 4. The username and password authenticates the recipient, based on the recipient's profile, as being authorized to receive the content of the secure message in accordance with the sender's instructions. The username and password for the recipient are sent to electronic content service provider 50 to authorize receiving the content of the secure message. Once the recipient is authenticated, a request is sent to electronic content service provider 50 to retrieve the secure message. The electronic content service provider 50 sends the content of the secure message to recipient computer 18. The content of the secure message is displayed in pop-up message window 126 on recipient computer 18, as shown in FIG. 13. The recipient can then view the content of the secure message originating from the sender.

The message window 126 is controlled by the object code on recipient computer 18, rather than the local internet browser. The object code on sender computer 12, recipient computer 18, and electronic content service provider 50 form a confirmation protocol or electronic handshake to establish authorization to view, i.e., who can read the content of the secure message. The sender defines the intended or authorized recipient, as well as specific parties or classes not authorized to view the secure message. The recipient confirms that he or she is the intended recipient by returning the recipient's authorization with the communication protocol link back to electronic content service provider 50. The electronic content service provider 50 recognizes the communication protocol link back from recipient computer 18, confirms the recipient as being authorized to view the secure message, and sends the content for viewing in message window 126 on recipient computer 18 under a restricted access. The recipient can then view the secure message in window 126. If the recipient's authorization cannot be verified by electronic content service provider 50, then access is denied and the secure message is not sent to recipient computer 18. An error message indicating that the recipient is not authorized to receive the secure message is sent instead.

The restricted access limits the use of the secure message on recipient computer 18. In response to receiving the secure message under restricted access, the object code on recipient computer 18 can inhibit forwarding, printing, local saving, or otherwise duplicating the content of the secure message. The recipient can do only what the sender authorizes, e.g., view the secure message on the computer display, but prevents unauthorized use of the content, e.g., printing, local saving, posting to another website, or otherwise transferring the content of the secure message to others. In any case, the restricted access is controllable by the sender.

The electronic handshake or confirmation protocol occurs each time the recipient opens or refreshes the secure message from the sender. Thus, at any time, even after the secure message 98 has been “posted”, sender computer 12 can terminate access or otherwise change access privileges to the secure message on electronic content service provider 50. The sender can set the secure message stored on electronic content service provider 50 to terminate access to the secure message. The electronic content service provider 50 will block all subsequent attempts to access the secure message. The next time the recipient attempts to access the secure message, access will be denied. Accordingly, electronic content service provider 50 has enabled the sender and recipient to send and receive secure messages, but the sender has retained control over the secure message. The recipient cannot forward, post, or copy the secure message, without the sender's knowledge or consent. The recipient can view the secure message only to the extent authorized by the sender and so long as the sender enables the recipient to do so.

The sender can also update the content associated with the secure message at any time. The secure message can be updated by the sender on electronic content service provider 50 and subsequent viewing of the secure message reflects the latest information. Each time the recipient opens or refreshes the secure message, the then current state of the content as stored on electronic content service provider computer 50, is sent to recipient computer 18 for viewing under restricted access as defined by the sender. The sender maintains control over the content of the secure message.

In another example, the sender needs to sends an email containing files to the recipient. The sender first enters username 82 and password 84 in login screen 86 as provided by the local plug-in in FIG. 4. Once the sender is authenticated, the plug-in directs the sender to the website of electronic content service provider 50 by link 80, as shown in FIG. 5. The sender is presented with a webpage on electronic content service provider 50 to manage email communication, similar to FIG. 6. The webpage shows emails that have been created using electronic content service provider 50. The sender selects compose message button.

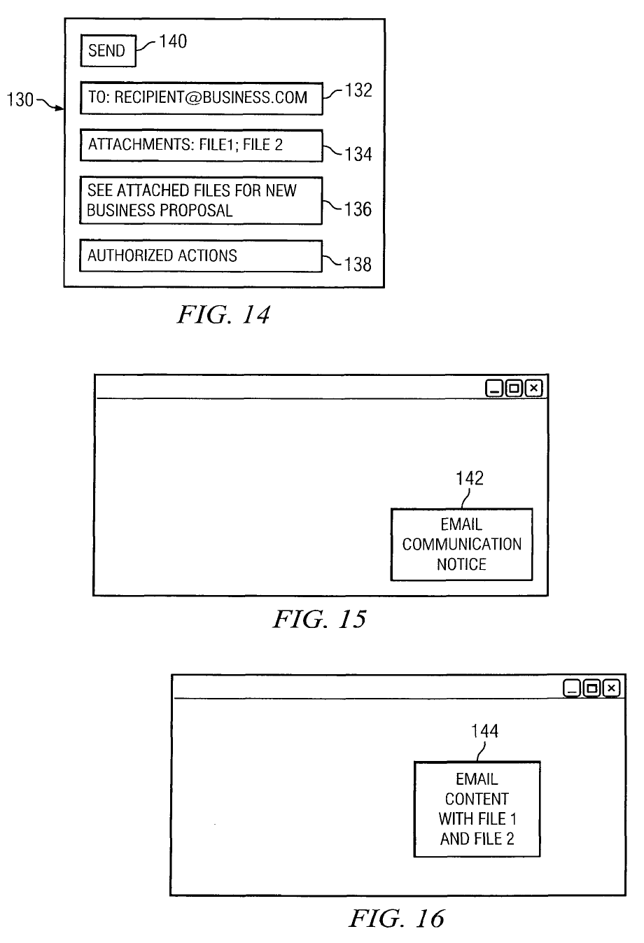

An email composition webpage 130 is presented, such as shown in FIG. 14. The sender composes the secure email including recipient email address in block 132. The attached files are shown in block 134. The files may contain text, figures, pictures, video, and any other content typically used on the Internet. Additional text is entered in block 136. The actions authorized by the sender, e.g., viewing but no saving, copying, printing, or forwarding, are defined in authorized actions block 138. When the sender clicks send button 140, electronic content service provider 50 generates a signature specific to the secure email content. The secure email from the sender is stored on electronic content service provider 50 for later retrieval by the authorized recipient. The signature is sent as a secure email communication notice to recipient computer 18.

The recipient receives the email communication notice 142 on recipient computer 18, as shown in FIG. 15. Alternatively, the email communication notice can be found in the recipient's local email application. To view the content of an email, the recipient clicks on email communication notice 142 and completes the login screen, similar to FIG. 4. The username and password authenticates the recipient, based on the recipient's profile, as being authorized to receive the content of the secure email in accordance with the sender's instructions. The username and password for the recipient are sent to electronic content service provider 50 to authorize receiving the content of the secure email. Once the recipient is authenticated, the electronic content service provider 50 sends the secure email with content to recipient computer 18. FIG. 16 shows the content of the secure email displayed in pop-up email window 144. The secure email can also be viewed in the recipient's local email application. The recipient can then view the secure email with text and file1 and file2 in window 144 under restricted access. The sender retains control over the content of the secure email.

In another example, the sender wants to make a secure document or other information available to the recipient through an independent business consortium or association. The secure document can include text, figures, pictures, and video. Again, the sender considers the document or information to be confidential and proprietary.

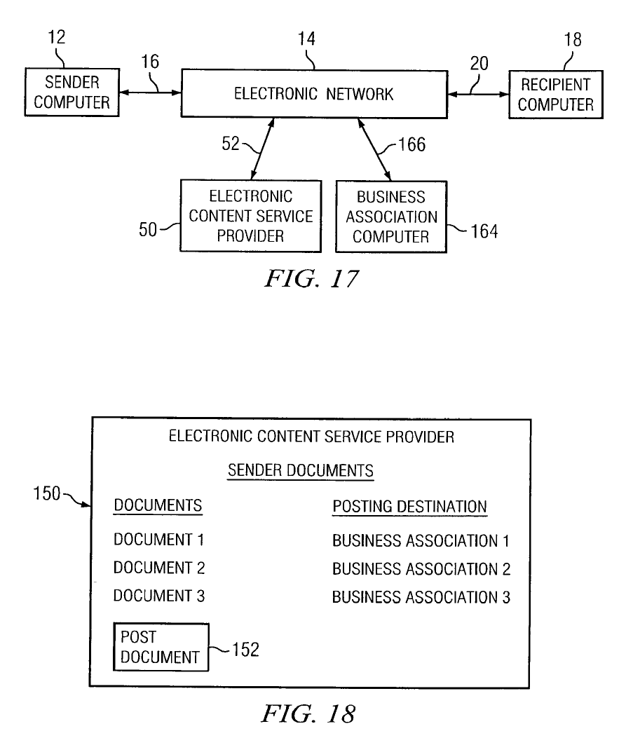

To post the secure document, the sender accesses a webpage on the website of electronic content service provider 50 by communication links 16 and 52, as shown in FIG. 17. The sender enters username and password in login screen as provided by the local plug-in in FIG. 4. Once the sender is authenticated, webpage 150 on electronic content service provider 50 is presented to manage posted documents, as shown in FIG. 18. Webpage 150 shows documents that have been posted by the sender via electronic content service provider 50. For example, document 1 has been previously posted with business association 1, document 2 has been posted with business association 2, and document 3 has been posted with business association 3. The sender selects post document button 152.

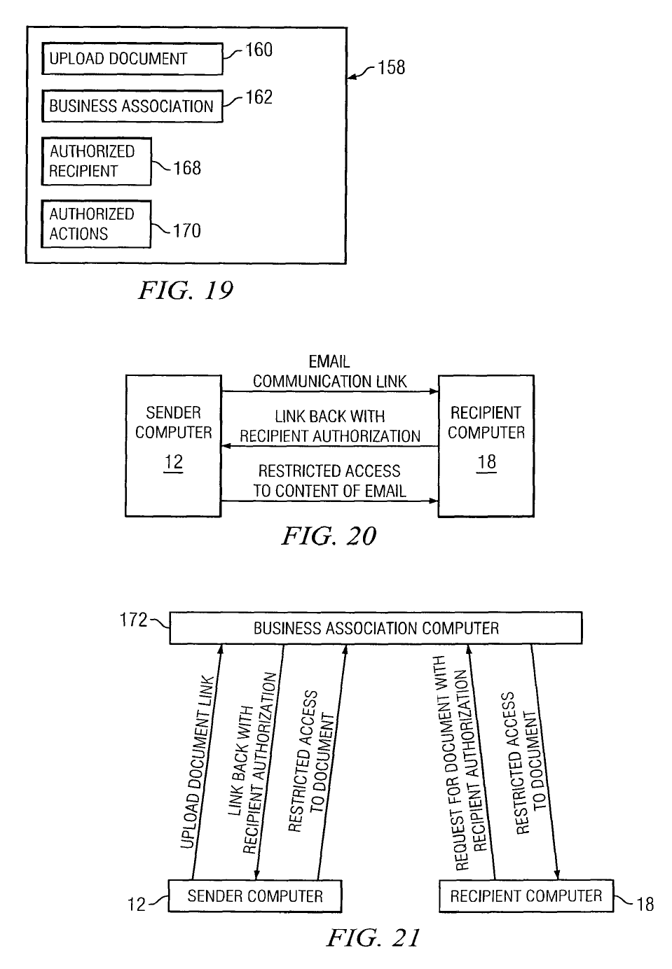

A document posting webpage 158 is presented, as shown in FIG. 19. The sender specifies the secure document to be uploaded or posted in block 160. The secure document may contain text, figures, pictures, video, and any other content typically used on the Internet. The sender identifies the business consortium or association that will be the access point for the secure document in block 162, in this case business association computer or server 164 in FIG. 17. Business association computer 164 is connected to electronic network 14 by communication link 166. Communication channel 166 is bi-directional and transmits data between business association computer 164 and electronic communication network 14 in a hard-wired or wireless configuration. In one embodiment, business association computer 164 is operated by an independent industry consortium oriented to a specific interest, such as technology, financial services, or public interest. Examples of the independent industry consortium could be a medical professional group, software developers association, support organization for military families, or business alliance of entrepreneurs. The sender and recipient belong to the independent industry consortium. The sender also indentifies attributes of the recipients authorized to view the secure document in block 168. The attributes are contained in the recipient's profile created during the registration process. For example, the sender identifies recipients that are members of the independent industry consortium, or customers of the sender, or users having cooperative agreement with the sender. The actions authorized by the sender, e.g., viewing but no saving, copying, printing, or forwarding, are defined in authorized actions block 170. When posting is complete, the sender's document is stored on electronic content service provider 50.

The electronic content service provider 50 sends a document link without content to business association computer 164. Business association computer 164 retains the secure document link in a searchable database. The recipient can search the database on business association computer 164 by way of electronic network 14 for documents of interest. When a document of interest is identified, the recipient enters username and password in the login screen provided by the local plug-in, similar to FIG. 4, and sends a request for the secure document to business association computer 164 to view the secure document. The object code in business association computer 164 forwards the document request to electronic content service provider 50 for verification.

The object code on sender computer 12, recipient computer 18, electronic content service provider 50, and business association computer 164 form a confirmation protocol or electronic handshake to establish authorization to view, i.e., who can read the secure document. The sender defines the intended or authorized recipient. The recipient confirms that he or she is the intended recipient by returning the recipient's authorization with the communication protocol link back through business association computer 164 to electronic content service provider 50. The electronic content service provider 50 recognizes the communication protocol link back from recipient computer 18, and confirms recipient computer 18 as being authorized to view the secure document. Once the recipient is authenticated, electronic content service provider 50 sends the content of the requested document to recipient computer 18 under a restricted access. The recipient can then view the secure document on recipient computer 18. If the recipient's authorization cannot be verified by electronic content service provider 50, then access is denied and the secure document is not sent to recipient computer 18. An error message indicating that the recipient is not authorized to receive the secure document is sent instead.

The restricted access limits the use of the secure document on recipient computer 18. In response to receiving the secure document under restricted access, the object code on recipient computer 18 inhibits forwarding, printing, local saving, or otherwise duplicating the content of the secure document. The recipient can do only what the sender authorizes, e.g., view the secure document on the computer display, but prevents unauthorized use of the content, e.g., printing, local saving, posting to another website, or otherwise transferring the content of the secure document to others. In another example, the sender may enable printing of the secure document, but inhibit local saving, posting, or transferring the content of the document. In any case, the restricted access is controllable by the sender.

The electronic handshake or confirmation protocol occurs each time the recipient opens or refreshes the secure document from the sender. Thus, at any time, even after the secure document has been “posted”, sender computer 12 can terminate access or otherwise change access privileges to the secure document on electronic content service provider 50. If the secure document becomes obsolete, the sender can prohibit further viewing or other dissemination of the document. The sender sets the secure document stored on electronic content service provider 50 to terminate access to the secure document. The electronic content service provider 50 will block all subsequent attempts to access the secure document. The next time the recipient attempts to access the secure document, access will be denied. Accordingly, electronic content service provider 50 has enabled the sender and recipient to send and receive documents, but the sender has retained control over the secure document. The recipient cannot forward, post, or copy the document, without the sender's knowledge or consent. The recipient can view the secure document only to the extent authorized by the sender and so long as the sender enables the recipient to do so.

The sender can also update the content associated with the secure document at any time. The sender can update the secure document on electronic content service provider 50 and subsequent viewing of the document reflects the latest information. Each time the recipient opens or refreshes the secure document, the then current state of the content is sent to recipient computer 18 for viewing under restricted access as defined by the sender. The issue of multiple versions of the secure document is resolved as only the most up-to-date content is transmitted to the recipient.

In another embodiment, electronic content service provider 50 can install object code or plug-ins on sender computer 12 and recipient computer 18 that provides for direct communication between the sender and recipient. Sender computer 12 and recipient computer 18 have registered with electronic content service provider 50 and installed the necessary object code or plug-in to control the following communication protocol. Sender computer 12 and recipient computer 18 each have a local email application and email service provider to enable the email communication. The sender composes the secure email on the local email application on computer 12 and attaches any necessary files or documents, as described in FIG. 14. The object code configures the local email application on sender computer 12 so that, when an email is sent, an email communication link without content is transmitted to recipient computer 18. At this stage, recipient computer 18 does not receive the secure email with its content from sender computer 12. The content of the secure email remains on sender computer 12. Recipient computer 18 receives only an email communication link without content of the secure email. The recipient must confirm authorization in order to read the content of the secure email.

FIG. 20 illustrates sender computer 12 sending the email communication link without content, and recipient computer 18 responding with email communication link back with authorization. Once the recipient is authenticated, sender computer 12 transmits the content of the secure email to recipient computer 18 for viewing in a manner similar to FIG. 16.

The object code on sender computer 12 and recipient computer 18 form a confirmation protocol or electronic handshake to establish authorization to view, i.e., who can read the secure email. The sender defines the intended or authorized recipient. The recipient confirms that he or she is the intended recipient by returning the recipient's authorization with the email communication link back. The object code on sender computer 12 recognizes the email communication link back from recipient computer 18, confirms recipient computer 18 as being authorized to view the secure email, and sends the content for viewing on recipient computer 18 under a restricted access, similar to FIG. 16. If the recipient's authorization cannot be verified by sender computer 12, then access is denied and the secure email are not transmitted to recipient computer 18. An error message indicating that the recipient is not authorized to receive the secure email is sent instead.

Continuing with the direct communication embodiment, the sender may want to post a document on a business consortium or association website. In this case, the sender accesses a webpage on business association computer 172 which provides the ability to upload a secure document, as shown in FIG. 21. Sender computer 12, recipient computer 18, and business association computer 172 have registered with electronic content service provider 50 and installed the necessary object code or plug-in to control the following communication protocol. The object code configures the local browser software on sender computer 12 so that, when the secure document is uploaded, a document link without content is transmitted to and stored on business association computer 172. FIG. 21 shows sender computer 12 uploading the document link without content to business association computer 172. The content of the secure document remains on sender computer 12. Business association computer 172 receives only the document link without content. The secure document link is stored in a searchable database on business association computer 172 and made available for download to authorized users. The recipient can search the database on business association computer 172 by way of electronic network 14 for documents of interest. The object code configures the local browser on recipient computer 18 so that, when a document of interest is selected, recipient computer 18 sends a request for the secure document with recipient's authorization to business association computer 172. The object code on business association computer 172 forwards recipient's request for document to sender computer 12.

The object code on sender computer 12 and recipient computer 18 and business association computer 172 form a confirmation protocol or electronic handshake to establish authorization to view, i.e., who can read the confidential document. The sender defines the authorized recipient. For example, the sender may authorize customers to receive the secure document but prohibit competitors from receiving the document. The recipient status as customer or competitor is contained within its authorization. The recipient confirms that he or she is an authorized recipient by returning the recipient's authorization with the document request link back. The object code on sender computer 12 recognizes the request for document link back from business association computer 172, confirms the profile of recipient computer 18 as being authorized to view the secure document, and sends the secure document for viewing through business association computer 172 to recipient computer 18 under a restricted access. FIG. 21 shows sender computer 12 sending the secure document through business association computer 172 to recipient computer 18 under restricted access. If the recipient's profile cannot be verified by the object code on sender computer 12, then access is denied and the secure document is not sent to recipient computer 18. An error message indicating that the recipient is not authorized to receive the secure document is sent instead.

The restricted access limits the use of the secure document on recipient computer 18. The object code on recipient computer 18 configures the local browser software to inhibit local save, printing, or otherwise duplicating the secure document. The recipient can do what the sender authorizes, e.g., view the secure document on the computer display, but prevents unauthorized use of the content, e.g., saving the document to the local hard disk. The restricted access is controllable by the sender. For example, the sender can enable printing of the secure document but inhibit local saving of the document on recipient computer 18.

The electronic handshake or confirmation protocol described in FIG. 21 occurs each time the user on recipient computer 18 requests access to the secure document from business association computer 172. Thus, at any time, even after the secure document has been uploaded, sender computer 12 can terminate access or otherwise change access privileges to the document. The sender sets the local browser to terminate access to the secure document, and the object code will block all subsequent attempts to access the document. The next time recipient computer 18 attempts to access the secure document, access will be denied. Accordingly, electronic content service provider 50 has enabled the recipient to download requested documents for viewing, but the sender has retained control over the secure document. The recipient can no longer print or save the document at will, without the sender's knowledge or consent. The recipient can access the secure document only to the extent authorized by the sender and so long as the sender enables the recipient to do so. Since the recipient cannot print or save the secure email, the ability to view the secure document is terminated at the sender's option.

The sender can also update the content associated with the secure document at any time. If the document changes, subsequent viewing of the document reflects the latest information as available from sender computer 12. Each time the recipient accesses the secure document, the then current state of the document is sent for viewing under restricted access as defined by the sender. The sender maintains control over the secure document.

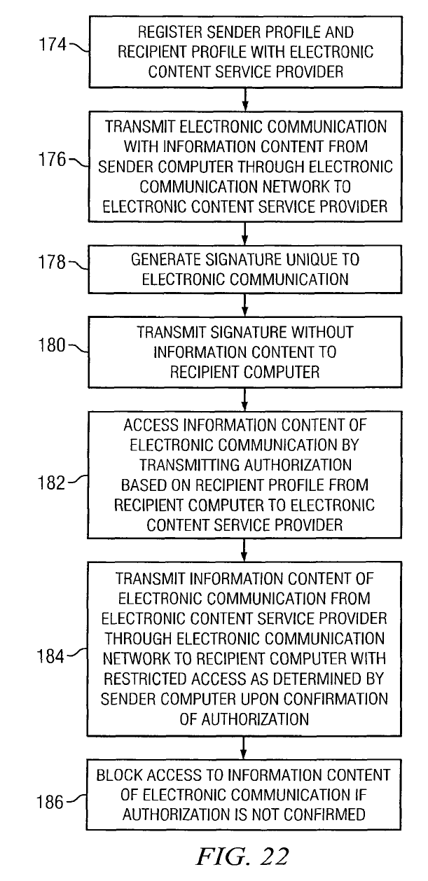

FIG. 22 is a flowchart of a method of controlling access to information content transmitted through an electronic communication network. In step 174, a sender profile and recipient profile is registered with an electronic content service provider. The sender profile and recipient profile includes name, address, business, and association. In step 176, an electronic communication with information content is transmitted from a sender computer through the electronic communication network to the electronic content service provider. The electronic communication can be a message or document. In step 178, a signature is generated unique to the electronic communication. In step 180, the signature without the information content is transmitted to a recipient computer. In step 182, the information content of the electronic communication is accessed by transmitting an authorization based on the recipient profile from the recipient computer to the electronic content service provider. In step 184, the information content of the electronic communication is transmitted from the electronic content service provider through the electronic communication network to the recipient computer with restricted access as determined by the sender computer upon confirmation of the authorization. The restricted access includes preventing the recipient computer from printing, duplicating, saving, or forwarding the information content of the electronic communication. In step 186, access to the information content of the electronic communication is blocked if the authorization is not confirmed. Access to the information content of the electronic communication can be terminated or changed under control of the sender computer. The information content of the electronic communication can be updated by the sender on the electronic content service provider.

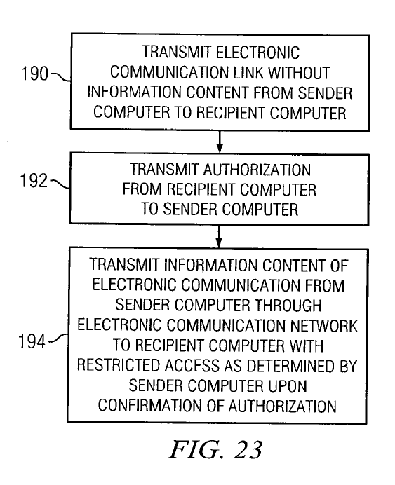

FIG. 23 is another flowchart of controlling access to information content transmitted through an electronic communication network. In step 190, an electronic communication link without the information content is transmitted from a sender computer to a recipient computer. In step 192, an authorization is transmitted from the recipient computer to the sender computer. In step 194, the information content of the electronic communication is transmitted from the sender computer through the electronic communication network to the recipient computer with restricted access as determined by the sender computer upon confirmation of the authorization. Access to the information content of the electronic communication is blocked if the authorization is not confirmed. The restricted access includes preventing the recipient computer from printing, duplicating, saving, or forwarding the information content of the electronic communication. Access to the information content of the electronic communication can be terminated or changed under control of the sender computer. The information content of the electronic communication can be updated by the sender on the sender computer.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of controlling access to information content transmitted through an electronic communication network, comprising:
registering a sender profile and recipient profile with an electronic content service provider;
transmitting an electronic communication with information content from a sender computer through the electronic communication network to the electronic content service provider;
generating a signature unique to the electronic communication;
transmitting the signature without the information content to a recipient computer;
accessing the information content of the electronic communication by transmitting an authorization based on the recipient profile from the recipient computer to the electronic content service provider;
transmitting the information content of the electronic communication from the electronic content service provider through the electronic communication network to the recipient computer with restricted access as determined by the sender computer upon confirmation of the authorization; and
blocking access to the information content of the electronic communication if the authorization is not confirmed.

2. The method of claim 1, wherein the restricted access includes preventing the recipient computer from printing, duplicating, saving, or forwarding the information content of the electronic communication.

3. The method of claim 1, wherein the electronic communication includes a message or document.

4. The method of claim 1, wherein the recipient profile includes name, address, business, and association.

5. The method of claim 1, further including changing access restrictions to the information content of the electronic communication under control of the sender computer.

6. The method of claim 1, further including updating the information content of the electronic communication on the electronic content service provider.

7. A method of controlling access to information content transmitted through an electronic communication network, comprising:
transmitting an electronic communication with information content from a sender computer through the electronic communication network to the electronic content service provider;
generating a signature unique to the electronic communication;
transmitting the signature without the information content to a recipient computer;
accessing the information content of the electronic communication by transmitting an authorization from the recipient computer to the electronic content service provider; and
transmitting the information content of the electronic communication from the electronic content service provider through the electronic communication network to the recipient computer with restricted access as determined by the sender computer.

8. The method of claim 7, further including blocking access to the information content of the electronic communication if the authorization is not confirmed.

9. The method of claim 7, wherein the restricted access includes preventing the recipient computer from printing, duplicating, saving, or forwarding the information content of the electronic communication.

10. The method of claim 7, wherein the electronic communication includes a message or document.

11. The method of claim 7, further including:
registering a sender profile with an electronic content service provider; and
registering a recipient profile with the electronic content service provider.

12. The method of claim 7, further including changing access restrictions to the information content of the electronic communication under control of the sender computer.

13. The method of claim 7, further including updating the information content of the electronic communication on the electronic content service provider.

14. A method of controlling access to information content transmitted through an electronic communication network, comprising:
transmitting an electronic communication link without the information content from a sender computer to a recipient computer;
transmitting an authorization from the recipient computer to the sender computer; and
transmitting the information content of the electronic communication from the sender computer through the electronic communication network to the recipient computer with restricted access as determined by the sender computer upon confirmation of the authorization.

15. The method of claim 14, further including blocking access to the information content of the electronic communication if the authorization is not confirmed.

16. The method of claim 14, wherein the restricted access includes preventing the recipient computer from printing, duplicating, saving, or forwarding the information content of the electronic communication.

17. The method of claim 14, further including:
registering a sender profile with an electronic content service provider; and
registering a recipient profile with the electronic content service provider.

18. The method of claim 14, further including changing access restrictions to the information content of the electronic communication under control of the sender computer.

19. The method of claim 14, further including updating the information content of the electronic communication on the sender computer.

20. A computer program product, comprising computer readable program code embodied in a computer usable medium, the computer readable program code adapted to implement a method for controlling access to information content transmitted through an electronic communication network, comprising:
transmitting an electronic communication with information content from a sender computer through the electronic communication network to an electronic content service provider;
generating a signature unique to the electronic communication;
transmitting the signature without the information content to a recipient computer;
accessing the information content of the electronic communication by transmitting an authorization from the recipient computer to the electronic content service provider; and
transmitting the information content of the electronic communication from the electronic content service provider through the electronic communication network to the recipient computer with restricted access as determined by the sender computer.

21. The computer program product of claim 20, further including blocking access to the electronic communication if the authorization is not confirmed.

22. The computer program product of claim 20, further including:
registering a sender profile with an electronic content service provider; and
registering a recipient profile with the electronic content service provider.

23. The computer program product of claim 20, wherein the restricted access includes preventing the recipient computer from printing, duplicating, saving, or forwarding the information content of the electronic communication.

24. The computer program product of claim 20, further including changing access restrictions to the information content of the electronic communication under control of the sender computer.

25. The computer program product of claim 20, wherein the electronic communication includes a document or document.
